(19) United States
(12) Patent Application Publication
(10) Pub. No.: US 2011/0036417 A1
(43) Pub. Date: Feb. 17, 2011

(54) PLUMBING SEALING ARRANGEMENT

(75) Inventor: James Edward McAlpine, Glasgow (GB)

Correspondence Address: FENWICK & WEST LLP, SILICON VALLEY CENTER, 801 CALIFORNIA STREET, MOUNTAIN VIEW, CA, 94041, US

(73) Assignee: McAlpine & Co. Limited, Glasgow (GB)

(21) Appl. No.: 12/810,139

(22) PCT Filed: Dec. 22, 2008
(86) PCT No.: PCT/GB08/04248

§ 371 Date: Sep. 23, 2010

(30) Foreign Application Priority Data
Dec. 22, 2007 (GB) 0725126.7

(51) Int. Cl. F16L 55/24

(52) U.S. Cl. 137/247.13

(57) ABSTRACT

A plumbing sealing arrangement (10) comprises a passageway having an inlet (14) adapted to be connected to a waste outlet (16) and an outlet adapted to be connected to a soil stack, a one way valve (18) located between the passageway inlet and outlet, the one way valve adapted to permit the passage of fluid through the passageway in one direction only from the inlet to the outlet and a trap (20) arranged to permit a liquid seal to be formed between the passageway inlet and the passageway outlet. In normal use, at least a portion of the one way valve is immersed in the liquid seal and in a described embodiment, an outlet of the valve is immersed in the liquid seal.

### FIELD OF THE INVENTION

The present invention relates to an improved plumbing sealing arrangement for use with waste outlets.

### BACKGROUND TO THE INVENTION

Traps, such as bottle traps or convoluted pipes, are widely used throughout the world to connect waste water outlets from sinks, baths or showers or the like to a soil stack. A conventional trap comprises an inlet and an outlet, and defines a passageway for liquid to flow from the inlet to the outlet. A conventional trap is designed such that, in use, liquid is retained in the passageway to provide a barrier between the inlet and the outlet, preventing odours and gases from the soil stack passing through the trap into the surrounding environment.

Whilst conventional traps are fairly effective, there are drawbacks associated with them. It is known, for example, for the liquid seal to evaporate over a period of time, such that the gases in the soil stack are no longer prevented from escaping through the waste outlet. This is particularly a problem where the waste outlet is not used regularly and/or the trap is located in a hot or low humidity environment in which the rate of evaporation is increased.

It is also known for a siphon effect to be established in a trap causing the liquid in the trap to be sucked out of the trap, thereby breaking the liquid seal.

### SUMMARY OF THE INVENTION

According to a first aspect of the present invention there is provided a plumbing sealing arrangement comprising:

a passageway having an inlet adapted to be connected to a waste outlet and an outlet adapted to be connected to a soil stack;

a one way valve located between the passageway inlet and outlet, the one way valve adapted to permit the passage of fluid through the passageway in one direction only from the inlet to the outlet; and

a trap arranged to permit a liquid seal to be formed between the passageway inlet and the passageway outlet;

wherein, in normal use, at least a portion of the one way valve is immersed in the liquid seal.

In one embodiment of the present invention, the sealing arrangement, in use provides a double barrier (a liquid barrier and a one-way valve) between a bath, shower or basin and a soil stack to which the sealing arrangement is connected. Immersing a portion of the one way valve in the liquid seal reduces the height of the sealing arrangement, permitting it to be used in confined spaces. Such an arrangement is useful in hot or low humidity environments where, for example, the liquid retained in a trap can evaporate permitting odours from the soil pipe to pass through the trap into the surrounding environment. The provision of a one-way valve, in addition to the liquid seal, provides a back-up seal in the event of the liquid seal failing. In the alternative, should the one-way valve become damaged and fail, the seal across the sealing arrangement is maintained by the liquid seal.

The trap may comprise a trap body defining an interior volume and a partitioning member for partitioning the interior volume. The partitioning member facilitates the provision of a liquid seal.

In one embodiment, the partitioning member comprises a tubular portion.

In another embodiment the one-way valve defines the partitioning member.

The trap may comprise at least two separable portions. For example, an upper body portion and lower body portion. Providing separable body portions may facilitate cleaning or access to the passageway.

Alternatively or additionally, the trap may be defined by a convoluted length of piping.

The one-way valve may be located adjacent the passageway inlet, but could be anywhere between the inlet and outlet.

In one embodiment, the one-way valve is located upstream of the trap. Locating the one-way valve upstream of the trap and, therefore, in use upstream of the liquid seal ensures that there is a barrier between the liquid and the environment surrounding the bath, shower or basin to which the plumbing sealing arrangement is connected. This will assist in preventing odours which may be emitted by the liquid from reaching the external environment.

The one-way valve may be removable from the sealing arrangement. Making the one-way valve removable facilitates replacement of the one-way valve becoming, for example, damaged.

In one embodiment, the one-way valve is located within the trap body. The one-way valve may be located in the trap body portion. The partitioning member may be adapted to receive the one-way valve. The partitioning member can assist in maintaining the one-way valve in an optimum orientation.

The one-way valve may be adapted to be trapped between the trap body and the partitioning member.

The one-way valve may comprise a duckbill shaped valve, but may comprise other valve forms, for example, such as a rubber diaphragm.

The one-way valve may comprise a first flexible wall and a second flexible wall, the first and second flexible walls being arranged to define a valve throughbore.

The first and second flexible walls may be arranged to normally lie in a valve throughbore closed position in which the valve throughbore is sealed. In this arrangement, the passage of fluid through the valve from a valve inlet to a valve outlet opens the valve throughbore permitting passage of the fluid.

A valve inlet may be held open by a valve flange connected to an upper portion of the first and second flexible walls.

The valve flange may be adapted to be trapped between the trap body and the partitioning member.

The one-way valve may comprise a polymeric material.

The one-way valve may be injection moulded or otherwise moulded.

In one embodiment, the one-way valve includes at least one crease or kink transverse to longitudinal valve axis. Incorporating a crease or kink biases the first and second flexible walls towards each other at the crease or kink, ensuring that a seal is maintained. Incorporating a crease or kink can permit a reduction in the length of the one-way valve without a loss of performance.

The valve outlet may be immersed, in normal use, in the liquid seal.

In one embodiment the valve outlet is lower than the passageway outlet.

According to a second aspect of the present invention, there is provided a trap comprising a passageway having an inlet adapted to be connected to a waste outlet and an outlet adapted to be connected to a soil stack, the trap being arranged to permit a liquid seal to be formed between the passageway inlet and the passageway outlet;

wherein the trap is adapted to accommodate a one-way valve in such a way that in normal use, at least a portion of the one way valve is immersed in the liquid seal.

The trap may incorporate a portion adapted for mounting the one-way valve.

The trap may include a portion for locating or clamping a flange defined by the one-way valve.

According to a third aspect of the present invention there is provided a plumbing sealing arrangement comprising:

a passageway having an inlet adapted to be connected to a waste outlet and an outlet adapted to be connected to a soil stack;

a one way valve located between the passageway inlet and outlet, the one way valve adapted to permit the passage of fluid through the passageway in one direction only from the inlet to the outlet; and

a trap arranged to permit a liquid seal to be formed between the passageway inlet and the passageway outlet;

wherein, in normal use, at least a portion of the one way valve is lower than the passageway outlet.

It will be understood that features listed as non-essential with respect to one aspect may be equally applicable to the other and have not been repeated for brevity.

### BRIEF DESCRIPTION OF THE DRAWINGS

An embodiment of the present invention will now be described with reference to the accompanying drawings in which:

FIG. 1 is a section view through a waste trap, according to an embodiment of the present invention; and

FIG. 2 is a perspective view of a one-way valve used in the trap of FIG. 1.

### DETAILED DESCRIPTION OF THE DRAWINGS

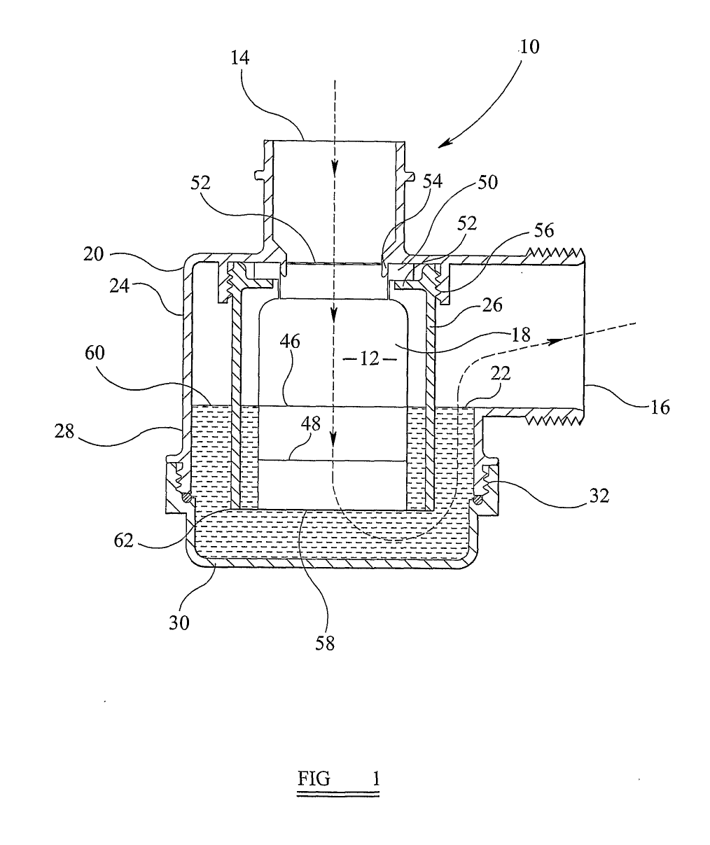

Reference is firstly made to FIG. 1, a section view showing a plumbing sealing arrangement generally indicated by reference numeral 10, according to an embodiment of the present invention.

The plumbing sealing arrangement 10 comprises a passageway 12 having an inlet 14 adapted to be connected to a waste outlet (not shown) and an outlet 16 adapted to be connected to a soil stack (not shown). A one-way valve 18 is located between the passageway inlet 14 and the passageway outlet 16, the one-way valve 18 is adapted to permit the passage of fluid through the passageway 22 in one direction only from the inlet 14 to the outlet 16.

The plumbing sealing arrangement 10 further comprises a trap 20 arranged to permit a liquid seal 22 to be formed between the passageway inlet 14 and the passageway outlet 16.

The trap 20 comprises a trap body 24 and a tubular partition 26. The trap body 24 comprises an upper trap body portion 28 and a lower trap body portion 30. The upper and lower trap body portions 28,30 are threadedly engaged by a threaded connection 32 permitting the lower trap body 30 to be removed from the upper trap body 28 to facilitate cleaning of the trap 20.

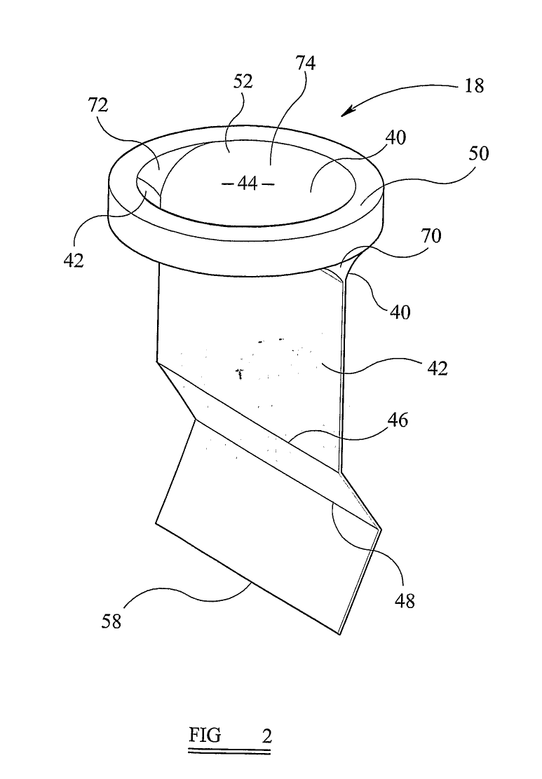

Referring to FIGS. 1 and 2, the one-way valve 18 is a polymeric duckbill shaped valve. The one-way valve 18 comprises a first flexible wall 40 and a second flexible wall 42 defining a valve throughbore 44. The first and second walls 40,42 are arranged such that over the majority of the length of the valve 18, the throughbore 44 is normally closed. As fluid passes through the one-way valve 18 from the sealing arrangement inlet 14 to the sealing arrangement outlet 16 the walls 40,42 are forced apart by the flow of liquid allowing passage through the valve throughbore 44. Once the flow of liquid has ceased, the throughbore 44 closes preventing odours or liquids flowing back through the valve from the sealing arrangement outlet 16 to the sealing arrangement inlet 14.

The seal provided by the one-way valve 18 is enhanced by the presence of a first kink 46 and a second kink 48, in a direction transverse to the longitudinal axis of the valve throughbore 44. The kinks 46,48 bring the first and second flexible walls 40,42 into a sealing engagement along the line of the kinks 46,48 ensuring a seal between the first and second walls 40,42 at those points at least.

The valve 18 further comprises a flange 50 of relatively thick material, the flange 50 being connected to the first and second walls 40,42 and adapted to hold the valve inlet 52 open to facilitate the flow of fluid through the valve 18 from the valve inlet 52 to the valve outlet 58. Gussets 70,72 are provided between upper ends of the first and second flexible walls 40,42 to ensure the valve throughbore 44 has a continuous internal surface 74.

Referring back to FIG. 1, it can be seen that in the plumbing sealing arrangement 10, the valve flange 50 is trapped between the trap body upper portion 28 and a radially inwardly extending lip 52 defined by the partitioning member 26. The one-way valve 18 is positively located by means of a spigot 54 defined by the upper body portion 28.

The one-way valve 18 is removable from the trap body 24 by disconnecting the lower trap body portion 30 from the upper trap body portion 28 and subsequently disconnecting the partitioning member 26 from the upper trap body portion 28, the partitioning member 26 being connected to the upper body portion 28 by a threaded connection 56. This arrangement facilitates removal of the one-way valve 18.

As can be seen from FIG. 1, the one-way valve outlet 58 is located within the liquid seal 22. This arrangement permits for a more compact apparatus 10 and surprisingly has no impact on the efficiency of the performance of the one-way valve 18 and, indeed, has been shown to enhance performance.

The provision of a one-way valve 18 provides a back-up seal between the inlet 14 and the outlet 16 in the event that the liquid level 60 drops below the partitioning member lower edge 62. Without the provision of the one-way valve 18, once the water level 60 drops below the partitioning member lower edge 62, gases from the soil stack can enter the trap outlet 16, pass under the partition lower edge 62 and pass up through the partition 26 and out through the trap inlet 14. Additionally, the one-way valve 18 resists back pressure from the soil stack.

Similarly, in the event that the one-way valve 18 fails due to, for example, a foreign body getting trapped between the flexible walls 40,42 and holding the valve throughbore 44 open, the presence of the liquid valve seal 22 ensures the integrity of the sealing arrangement 10 remains intact.

Various modifications or improvements may be made to the above descried embodiment without departing from the scope of the invention. For example, although the trap is shown as a body portion and a partitioning member, a liquid seal could be formed from a convoluted length of pipe.

1. A plumbing sealing arrangement comprising:
a passageway having an inlet adapted to be connected to a waste outlet and an outlet adapted to be connected to a soil stack;
a one way valve located between the passageway inlet and outlet, the one way valve adapted to permit the passage of fluid through the passageway in one direction only from the inlet to the outlet; and
a trap arranged to permit a liquid seal to be formed between the passageway inlet and the passageway outlet;
wherein, in normal use, at least a portion of the one way valve is immersed in the liquid seal.

2. The plumbing sealing arrangement of claim 1, wherein the trap comprises a trap body defining an interior volume and a partitioning member for partitioning the interior volume.

3. The plumbing sealing arrangement of claim 2, wherein the partitioning member comprises a tubular portion.

4. The plumbing sealing arrangement of either of claim 2 or 3, wherein the one-way valve defines the partitioning member.

5. The plumbing sealing arrangement of any preceding claim, wherein the trap comprises at least two separable portions.

6. The plumbing sealing arrangement of claim 5, wherein the trap comprises an upper body portion and lower body portion.

7. The plumbing sealing arrangement of claim 1, wherein the trap is defined by a convoluted length of piping.

8. The plumbing sealing arrangement of any preceding claim, wherein the one-way valve is located adjacent the passageway inlet, but could be anywhere between the inlet and outlet.

9. The plumbing sealing arrangement of any preceding claim, wherein the one-way valve is located upstream of the trap.

10. The plumbing sealing arrangement of any preceding claim, wherein the one-way valve is removable from the sealing arrangement.

11. The plumbing sealing arrangement of claim 2, wherein the one-way valve is located within the trap body.

12. The plumbing sealing arrangement of claim 6, wherein the one-way valve is located in the upper body portion.

13. The plumbing sealing arrangement of claim 3, wherein the partitioning member is adapted to receive the one-way valve.

14. The plumbing sealing arrangement of claim 3, wherein the one-way valve is adapted to be trapped between the trap body and the partitioning member.

15. The plumbing sealing arrangement of any preceding claim, wherein the one-way valve comprises a duckbill shaped valve

16. The plumbing sealing arrangement of any preceding claim, wherein the one-way valve comprises an elastomer diaphragm.

17. The plumbing sealing arrangement of any preceding claim, wherein the one-way valve comprises a first flexible wall and a second flexible wall, the first and second flexible walls being arranged to define a valve throughbore.

18. The plumbing sealing arrangement of claim 17, wherein the first and second flexible walls are arranged to normally lie in a valve throughbore closed position in which the valve throughbore is sealed

19. The plumbing sealing arrangement of either of claim 17 or 18, wherein a valve inlet is held open by a valve flange connected to an upper portion of the first and second flexible walls.

20. The plumbing sealing arrangement of claim 19, wherein the valve flange is adapted to be trapped between the trap body and the partitioning member.

21. The plumbing sealing arrangement of any preceding claim, wherein the one-way valve comprise a polymeric material.

22. The plumbing sealing arrangement of any preceding claim, wherein the one-way valve is injection moulded or otherwise moulded.

23. The plumbing sealing arrangement of any preceding claim, wherein the one-way valve includes at least one crease or kink transverse to longitudinal valve axis.

24. The plumbing sealing arrangement of any preceding claim, wherein a valve outlet is immersed, in normal use, in the liquid seal.

25. The plumbing sealing arrangement of any preceding claim, wherein a valve outlet is lower than the passageway outlet.

26. A trap comprising a passageway having an inlet adapted to be connected to a waste outlet and an outlet adapted to be connected to a soil stack, the trap being arranged to permit a liquid seal to be formed between the passageway inlet and the passageway outlet;
wherein the trap is adapted to accommodate a one-way valve in such a way that in normal use, at least a portion of the one way valve is immersed in the liquid seal.

27. The trap of claim 26, wherein the trap incorporates a portion adapted for mounting the one-way valve.

28. The trap of either of claim 26 or 27, wherein the trap includes a portion for locating or clamping a flange defined by the one-way valve.

29. A plumbing sealing arrangement comprising:
a passageway having an inlet adapted to be connected to a waste outlet and an outlet adapted to be connected to a soil stack;
a one way valve located between the passageway inlet and outlet, the one way valve adapted to permit the passage of fluid through the passageway in one direction only from the inlet to the outlet; and
a trap arranged to permit a liquid seal to be formed between the passageway inlet and the passageway outlet;
wherein, in normal use, at least a portion of the one way valve is lower than the passageway outlet.
